(19) United States
(12) Patent Application Publication
(10) Pub. No.: US 2026/0034697 A1
(43) Pub. Date: Feb. 5, 2026

(54) METHOD FOR REGULATING AND CONTROLLING ULTRASONIC CUTTING SPEED OF OUTER PARABOLOID OF HONEYCOMB MATERIAL

(71) Applicant: Jiangsu Branch of China Academy of Machinery Science and Technology Group Co., Ltd., Changzhou City (CN)

(72) Inventors: Bailiang ZHUANG, Changzhou City (CN); Yundian ZHANG, Changzhou City (CN); Lu SHEN, Changzhou City (CN); Lin WANG, Changzhou City (CN); Zifeng ZHOU, Changzhou City (CN); Qing XU, Changzhou City (CN); Yu XIA, Changzhou City (CN)

(21) Appl. No.: 19/251,426

(22) Filed: Jun. 26, 2025

(30) Foreign Application Priority Data
Jul. 31, 2024 (CN) 202411039013.X

(51) Int. Cl. B26D 5/20; B26D 5/00; B26D 7/08

(52) U.S. Cl. CPC B26D 5/20; B26D 7/086; B26D 5/005; B26D 2210/00

(57) ABSTRACT

A method for regulating and controlling an ultrasonic cutting speed of an outer paraboloid of a honeycomb material is provided. The method includes: regulating and controlling an ultrasonic cutting speed of an outer end face of a honeycomb blank, an ultrasonic cutting speed of an outer paraboloid of the honeycomb blank in a roughing stage, an ultrasonic cutting speed of the outer paraboloid of the honeycomb blank in a first finishing stage, an ultrasonic cutting speed of the outer paraboloid of the honeycomb blank in a second finishing stage, and an ultrasonic cutting speed of an outer peripheral face of the honeycomb blank. The ultrasonic cutting method according to the present disclosure in which the ultrasonic cutting speed V is kept constant can improve the machining quality of parts with the outer paraboloid of the honeycomb material and ensure the service life of a sharp knife.

### CROSS-REFERENCE TO RELATED APPLICATION

This patent application claims the benefit and priority of Chinese Patent Application No. 202411039013.X filed with the China National Intellectual Property Administration on Jul. 31, 2024, the disclosure of which is incorporated by reference herein in its entirety as part of the present application.

### TECHNICAL FIELD

The present disclosure relates to the technical field of honeycomb material processing, and in particular to a method for regulating and controlling an ultrasonic cutting speed of an outer paraboloid of a honeycomb material.

### BACKGROUND

Parts with outer paraboloids of honeycomb materials have been widely adopted in aerospace, electronics, and other fields. A numerical control ultrasonic cutting machine tool is a high-end processing device for honeycomb materials. Ultrasonic cutting speed is an important parameter of the numerical control ultrasonic cutting machine tool for the outer paraboloid of the honeycomb material, which directly affects the machining quality of the parts with the outer paraboloid of the honeycomb material and the service life of a sharp knife. An ultrasonic cutting speed regulation and control system is a core component of the numerical control ultrasonic cutting machine tool for the outer paraboloid of the honeycomb material, and for this system, it is needed to provide a method for regulating and controlling the ultrasonic cutting speed of the outer paraboloid of the honeycomb material.

At present, a rotary platform of the ultrasonic cutting machine tool for the outer paraboloid of the honeycomb material is constant in rotational speed, but the ultrasonic cutting speed is variable. The traditional regulation and control method of the ultrasonic cutting speed has the following advantages: there is no need to adjust the rotational speed of the rotary platform, so there is no need to add a control system to the rotary platform, no need to transform the numerical control ultrasonic cutting machine tool and hence no need to increase the machining cost. However, the traditional regulation and control method of the ultrasonic cutting speed has the following disadvantages: the machining quality of the outer paraboloid of the honeycomb material is poor, the service life of the sharp knife is short, and the part with the outer paraboloid of the honeycomb material is low in qualification rate.

In addition, since the rotary platform of the numerical control ultrasonic cutting machine tool is kept unchanged in rotational speed during ultrasonic cutting, the diameter of a cutting point where the part with the outer paraboloid of the honeycomb material is located varies from 0 to 4500 mm, which may lead to a sharp change in the cutting speed of the numerical control ultrasonic cutting machine tool (its cutting speed varies from 0 to 800 m/min), severely impacting the machining quality of the part with the outer paraboloid of the honeycomb material and the service life of the sharp knife.

### SUMMARY

Technical problems to be solved by the present disclosure are described as below. In order to solve the technical problems of poor machining quality of a part with an outer paraboloid of a honeycomb material in a ultrasonic cutting mode (in which a rotary platform has a constant rotational speed) and short service life of a sharp knife, the present disclosure provides a method for regulating and controlling an ultrasonic cutting speed of an outer paraboloid of a honeycomb material, which, by an ultrasonic cutting mode of adjusting the rotational speed of the rotary platform to realize a constant ultrasonic cutting speed, can improve the machining quality of the part of the outer paraboloid of the honeycomb material and ensure the service life of the sharp knife.

Technical solutions adopted by the present disclosure to solve the above technical problems are described as below. A method for regulating and controlling an ultrasonic cutting speed of an outer paraboloid of a honeycomb material includes the following steps:
step 1, regulating and controlling an ultrasonic cutting speed of an outer end face of a honeycomb blank: regulating and controlling a rotational speed n of a rotary platform according to a diameter D of a cutting point of the honeycomb blank to keep the ultrasonic cutting speed of the honeycomb blank at a constant value V1;
step 2, regulating and controlling an ultrasonic cutting speed of an outer paraboloid of the honeycomb blank in a roughing stage: regulating and controlling the rotational speed n of the rotary platform according to the diameter D of the cutting point of the honeycomb blank to keep the ultrasonic cutting speed of the honeycomb blank at a constant value V2;
step 3, regulating and controlling an ultrasonic cutting speed of the outer paraboloid of the honeycomb blank in a first finishing stage: adjusting the rotational speed n of the rotary platform to a preset rotational speed value n0 and keeping the rotational speed constant, regulating and controlling an ultrasonic cutting speed V of the honeycomb blank according to the diameter D of the cutting point of the honeycomb blank until the ultrasonic cutting speed V is equivalent to a preset ultrasonic cutting speed value V0 of the honeycomb blank, and executing step 4;
step 4, regulating and controlling an ultrasonic cutting speed of the outer paraboloid of the honeycomb blank in a second finishing stage: regulating and controlling the rotational speed n of the rotary platform according to the diameter D of the cutting point of the honeycomb blank to keep the ultrasonic cutting speed of the honeycomb blank at a constant value V3; and
step 5, regulating and controlling an ultrasonic cutting speed of an outer peripheral face of the honeycomb blank: adjusting the rotational speed n of the rotary platform to a preset rotational speed value n4 to keep the ultrasonic cutting speed of the honeycomb blank at a constant value V4;
where V1=V2=V3=V4.

Therefore, the ultrasonic cutting speed is an important parameter of a numerical control ultrasonic cutting machine tool for the outer paraboloid of the honeycomb material, which directly affects the machining quality of the outer paraboloid of the honeycomb material and the wear of a sharp knife. In addition, the ultrasonic cutting speed V is affected by the diameter D of the cutting point and the rotational speed n of the rotary platform. Thus, compared with an ultrasonic cutting method in which the rotational speed n of the rotary platform is unchanged and the ultrasonic cutting speed V is changed, the ultrasonic cutting method in which the ultrasonic cutting speed V is kept constant by adjusting the rotational speed n of the rotary platform in all ultrasonic cutting areas other than an area near a point 0 of the outer paraboloid of the honeycomb material can ensure the consistent machining quality of each position of the outer paraboloid of the honeycomb material, which in turn can improve the machining quality of the honeycomb blank. Meanwhile, it can be ensured that the sharp knife is always worn at a normal wear speed, rather than being subjected to severe wear or abnormal damage, which in turn can ensure the service life of the sharp knife.

In an embodim, the ultrasonic cutting speed V of the honeycomb blank is calculated according to a formula:

$$V = \frac{π \times n \times D}{1000} ;$$

where the rotational speed n of the rotary platform is in units of r/min, the diameter D of the cutting point of the honeycomb blank is in units of: mm, and the ultrasonic cutting speed V of the honeycomb blank is in units of: m/min.

In an embodiment, building a three-dimensional coordinate system is that: a three-dimensional coordinate system is built by taking a center point 0 of an upper surface of the honeycomb blank as an origin point.

In an embodiment, the diameter D of the cutting point of the honeycomb blank is: twice a distance between the cutting point of the honeycomb blank and a Z axis.

In an embodiment, the step 1 includes the following steps:
step 1-1, dividing ultrasonic cutting of the outer end face into two stages AB and BC;
step 1-2, regulating and controlling an ultrasonic cutting speed of the outer end face of the honeycomb blank in the stage AB: regulating and controlling the rotational speed n of the rotary platform according to the diameter D of the cutting point of the honeycomb blank to keep the cutting speed of the honeycomb blank at the constant value V1; and
step 1-3, regulating and controlling an ultrasonic cutting speed of the outer end face of the honeycomb blank in the stage BC: regulating and controlling the rotational speed n of the rotary platform according to the diameter D of the cutting point of the honeycomb blank to keep the cutting speed of the honeycomb blank at the constant value V1;
where a point B is a midpoint of AC. Thus, since the diameter D of the cutting point of the outer end face changes a lot, the rotational speed n of the rotary platform is subject to a great gradient change when the rotational speed n of the rotary platform is adjusted directly, which is not conductive to the ultrasonic cutting of the honeycomb blank. Therefore, dividing the ultrasonic cutting of the outer end face into the two stages AB and BC can further improve the ultrasonic cutting quality of the outer end face of the honeycomb material.

In an embodiment, in step 1, requirements for ultrasonic cutting of the outer end face are as follows: a cutting depth L1, a cutting length L2, and a radius L4 of a cylinder left by the honeycomb blank after ultrasonic cutting; a cutting path of the outer end face is: a straight line parallel to an XOY plane; and a variation trend of the diameter D of the cutting point of the honeycomb blank is a straight line.

In an embodiment, in step 1, coordinates of a point A are (−(L4+L2), −L1), coordinates of a point B are (−(L4+L2/2), −L1), and coordinates of a point C are (−L4, −L1); the diameter D of the cutting point of the honeycomb blank is 2 (L4+L2) when the cutting point of the honeycomb blank is the point A; the diameter D of the cutting point of the honeycomb blank is 2L4+L2 when the cutting point of the honeycomb blank is the point B; and the diameter D of the cutting point of the honeycomb blank is 2L4 when the cutting point of the honeycomb blank is the point C.

In an embodiment, in step 2, a requirement for cutting the outer paraboloid in the roughing stage is as follows: a spacing between a cutting face and the outer paraboloid is L3; a cutting path of the outer paraboloid in the roughing stage is: forming an angle α with an XOY plane, and 0°<α<90°; and a variation trend of the diameter D of the cutting point of the honeycomb blank is a straight line.

In an embodiment, in the step 3 and in the step 4, a cutting path of the outer paraboloid in the finishing stage is: a parabola taking an XOZ plane or a YOZ plane as a reference plane and passing through points 0 and C; and a variation trend of the diameter D of the cutting point of the honeycomb blank is a parabola.

In an embodiment, in the step 5, a cutting path of the outer peripheral surface is: a straight line parallel to a Z axis and passing through a point A; the diameter D of the cutting point of the honeycomb blank remains unchanged, and D=2 (L4+L2); and
a cutting speed value V4 of the honeycomb blank is calculated according to a formula:

$$V 4 = \frac{π \times n 4 \times 2 ( L 4 + L 2 )}{1000} .$$

Compared with the prior art, the present disclosure has the following beneficial effects.

The ultrasonic cutting speed is an important parameter of a numerical control ultrasonic cutting machine tool for the outer paraboloid of the honeycomb material, which directly affects the machining quality of the outer paraboloid of the honeycomb material and the wear of the sharp knife. In addition, the ultrasonic cutting speed V is affected by the diameter D of the cutting point and the rotational speed n of the rotary platform. Thus, compared with an ultrasonic cutting method in which the rotational speed n of the rotary platform is unchanged but the ultrasonic cutting speed V is changed, the ultrasonic cutting method in which the ultrasonic cutting speed V is kept constant by adjusting the rotational speed n of the rotary platform in all ultrasonic cutting areas other than an area near a point 0 of the outer paraboloid of the honeycomb material can ensure the consistent machining quality of each position of the outer paraboloid of the honeycomb material, which in turn can improve the machining quality of the honeycomb blank. Meanwhile, it can be ensured that the sharp knife is always worn at a normal wear speed, rather than being subjected to severe wear or abnormal damage, which in turn can ensure the service life of the sharp knife.

### BRIEF DESCRIPTION OF THE DRAWINGS

The present disclosure will be further described below with reference to the accompanying drawings and embodiments.

FIG. 1 is a flowchart of a method for regulating and controlling an ultrasonic cutting speed of an outer paraboloid of a honeycomb material according to an embodiment of the present disclosure;

FIG. 2 is a flowchart illustrating an ultrasonic cutting effect of the outer paraboloid of the honeycomb material according to an embodiment of the present disclosure;

FIG. 3 is a flowchart illustrating a sectional-view effect of ultrasonic cutting of the outer paraboloid of the honeycomb material according to an embodiment of the present disclosure;

FIG. 4 is a flowchart of step 1 of the method for regulating and controlling an ultrasonic cutting speed of an outer paraboloid of a honeycomb material according to an embodiment of the present disclosure;

FIG. 5 is a diagram illustrating a sectional-view effect of ultrasonic cutting of the honeycomb material on an outer end face, the outer paraboloid and an outer peripheral face according to an embodiment of the present disclosure;

FIG. 6 is a diagram illustrating a sectional-view effect of the outer paraboloid of the honeycomb material in an ultrasonic cutting stage according to an embodiment of the present disclosure;

FIG. 7 is a schematic structural diagram of an ultrasonic cutting device for the outer paraboloid of the honeycomb material according to an embodiment of the present disclosure; and

FIG. 8 is a schematic structural diagram of a sharp knife according to an embodiment of the present disclosure.

In the figures: 1-Honeycomb blank; 101-Outer end face; 102-Outer paraboloid; 103-Outer peripheral face; 2-Rotary platform; 3-Driving mechanism; 4-Sharp knife; 5. Six-degrees-of-freedom (Six-DOF) robot; 6. Amplitude transformer; 7-Ultrasonic transducer; 8-Adapter board.

### DETAILED DESCRIPTION OF THE EMBODIMENTS

The present disclosure will be further described in detail with reference to the accompanying drawings. These accompanying drawings are simplified schematic diagrams illustrating the basic structure of the present disclosure merely schematically, and thus the accompanying drawings show only compositions relevant to the present disclosure.

In the description of the present disclosure, it should be understood that orientation or position relationships indicated by terms such as “center”, “longitudinal”, “transverse”, “length”, “width”, “thickness”, “up”, “down”, “front”, “rear”, “left”, “right”, “vertical”, “horizontal”, “top”, “bottom”, “inside”, “outside”, “clockwise”, “counterclockwise”, “axial”, “radial”, “circumferential”, etc. are based on orientation or position relationships shown in the accompanying drawings and are merely for ease of description of the present disclosure and simplification of the description, rather than indicating or implying that the devices or elements referred to must have a specific orientation or be constructed and operated in a specific orientation, and therefore cannot be construed as limiting the present disclosure. In addition, features defined by “first” and “second” may explicitly or implicitly include one or more of the features. In the description of the present disclosure, “multiple” means two or more, unless otherwise specified.

In the description of the present disclosure, it should also be noted that, the terms “mount”, “connected”, or “connect” should be interpreted in a broad sense unless explicitly defined and limited otherwise. For example, they may be a fixed connection, a detachable connection, or an integral connection; or may be a mechanical connection or an electrical connection; may be a direct connection, an indirect connection by means of an intermediary, or may be an internal communication between two elements. For those of ordinary skill in the art, the specific meanings of the terms mentioned above in the present disclosure should be construed according to specific circumstances.

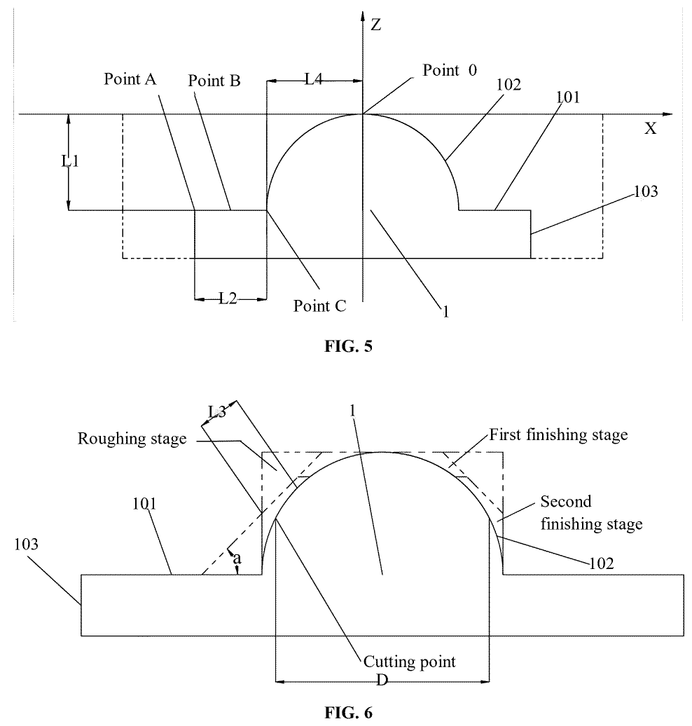

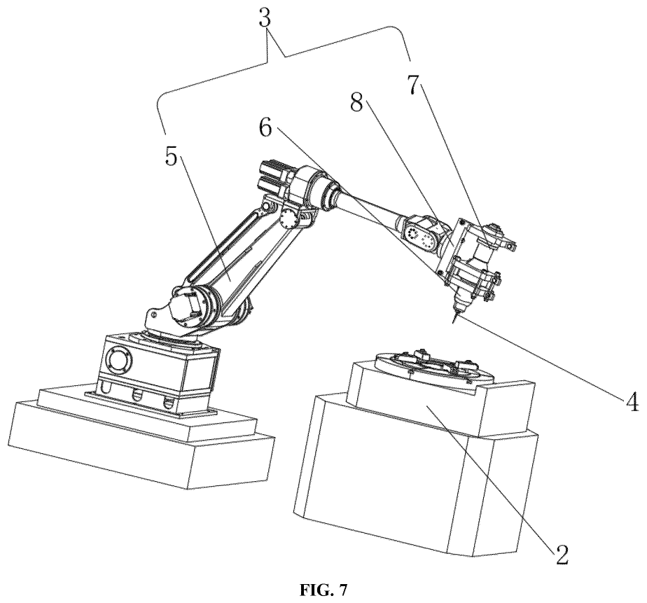

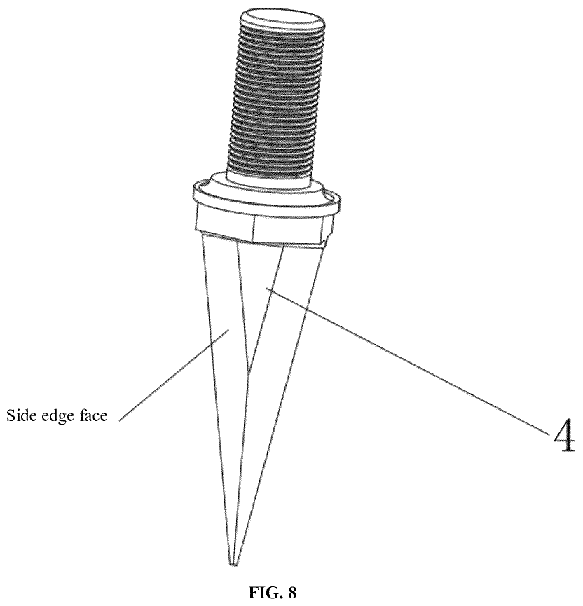

As shown in FIGS. 1 to 8, which illustrate embodiments of the present disclosure, according to these embodiments, a method for regulating and controlling an ultrasonic cutting speed of an outer paraboloid of a honeycomb material includes the following steps:
S1, regulating and controlling an ultrasonic cutting speed of an outer end face 101 of a honeycomb blank 1: a rotational speed n of a rotary platform 2 is regulated and controlled according to a diameter D of a cutting point of the honeycomb blank 1 to keep the ultrasonic cutting speed of the honeycomb blank 1 at a constant value V1;
S2, regulating and controlling an ultrasonic cutting speed of an outer paraboloid 102 of the honeycomb blank 1 in a roughing stage: the rotational speed n of the rotary platform 2 is regulated and controlled according to the diameter D of the cutting point of the honeycomb blank 1 to keep the ultrasonic cutting speed of the honeycomb blank 1 at a constant value V2;
S3, regulating and controlling an ultrasonic cutting speed of the outer paraboloid 102 of the honeycomb blank 1 in a first finishing stage: the rotational speed n of the rotary platform 2 is adjusted to a preset rotational speed value n0 and is kept constant, and an ultrasonic cutting speed V of the honeycomb blank 1 is regulated and controlled according to the diameter D of the cutting point of the honeycomb blank 1 until the ultrasonic cutting speed V is equivalent to a preset ultrasonic cutting speed value V0 of the honeycomb blank 1, and S4 is executed;
S4, regulating and controlling an ultrasonic cutting speed of the outer paraboloid 102 of the honeycomb blank 1 in a second finishing stage: regulating and controlling the rotational speed n of the rotary platform 2 is regulated and controlled according to the diameter D of the cutting point of the honeycomb blank 1 to keep the ultrasonic cutting speed of the honeycomb blank 1 at a constant value V3; and
S5, regulating and controlling an ultrasonic cutting speed of an outer peripheral face 103 of the honeycomb blank 1: the rotational speed n of the rotary platform 2 is adjusted to a preset rotational speed value n4 to keep the ultrasonic cutting speed of the honeycomb blank 1 at a constant value V4;
where V1=V2=V3=V4. Therefore, the ultrasonic cutting speed is an important parameter of a numerical control ultrasonic cutting machine tool for the outer paraboloid 102 of the honeycomb material, which directly affects the machining quality of the outer paraboloid 102 of the honeycomb material and the wear of a sharp knife 4. In addition, the ultrasonic cutting speed V is affected by the diameter D of the cutting point and the rotational speed n of the rotary platform 2. Thus, compared with an ultrasonic cutting method in which the rotational speed n of the rotary platform 2 is unchanged but the ultrasonic cutting speed V is changed, the ultrasonic cutting method in which the ultrasonic cutting speed V is kept constant by adjusting the rotational speed n of the rotary platform 2 in all ultrasonic cutting areas other than an area near a point 0 of the outer paraboloid 102 of the honeycomb material can ensure the consistent machining quality of each position (i.e., each cutting point) of the outer paraboloid 102 of the honeycomb material, which in turn can improve the machining quality of the honeycomb blank 1. Meanwhile, it can be ensured that the sharp knife 4 is always worn at a normal wear speed, rather than being subjected to severe wear or abnormal damage, which in turn can ensure the service life of the sharp knife 4.

In other words, since the cutting speed of each position of the honeycomb blank 1 is kept constant, the machining quality of each position of the honeycomb blank 1 is consistent, which avoids that a change in the ultrasonic cutting speed at a certain position (i.e., the ultrasonic cutting speed of this position is not consistent with those of other positions) leads to a change in the ultrasonic cutting effect at this position (i.e., the ultrasonic cutting effect of this position is consistent with those of other positions, and the outer end face 101, the outer paraboloid 102 and the outer peripheral face 103 are not continuous and smooth faces). Thus, the machining quality of the honeycomb blank 1 can be improved.

In other words, in an area near the point 0, since the diameter D of the cutting point is small, the ultrasonic cutting speed V is low. Therefore, in this stage (i.e., in the first finishing stage of the outer paraboloid 102 of the honeycomb blank 1), the change of the ultrasonic cutting speed V (i.e., a preset ultrasonic cutting speed value in this stage) is V0, the ultrasonic cutting time in this stage is short, and the impact on the machining quality of the honeycomb blank 1 is negligible, so that the rotational speed n of the rotary platform 2 is constant at a preset rotational speed value n0, which is more conducive to controlling ultrasonic cutting in this stage.

In other words, the wear of the sharp knife 4 at various positions is inconsistent when the ultrasonic cutting speed V of the honeycomb blank 1 changes, so it is not possible to ensure that the sharp knife 4 is worn at a normal wear speed. The changing ultrasonic cutting speed may cause severe wear or abnormal damage to the sharp knife 4, which may aggravate the wear of the sharp knife 4 and shorten the service life of the sharp knife 4.

What need to be noted are described as below: firstly, a part with an outer paraboloid 102 of a honeycomb material is a core part of an aerospace vehicle and other products, the material of the honeycomb blank 1 itself is expensive, a low product qualification rate may result in a sharp rise in the production cost, the machining quality of the part with the outer paraboloid 102 of the honeycomb material may directly affect its performance, moreover, a material processing tool (i.e., the sharp knife 4) of the honeycomb blank 1 is expensive, and the range of normal wear of the sharp knife 4 by ultrasonic cutting is limited to 3000 metres. Therefore, during production of the part with the outer paraboloid 102 of the honeycomb material, it is of great significance to improve the machining quality of the outer paraboloid 102 of the honeycomb material, prevent the sharp knife 4 from being severely worn or abnormally damaged, and ensure the service life of the sharp knife 4, by the ultrasonic cutting method in which the ultrasonic cutting speed V of the honeycomb blank 1 is kept constant;
secondly, the determination of the diameter D of the cutting point: first, a three-dimensional coordinate system is built by taking a center point 0 of an upper surface of the honeycomb blank 1 as an origin point, and then a position of a contact point (i.e., the cutting point) between the sharp knife 4 and the honeycomb blank 1 relative to the point 0 is acquired in real time by a numerical control program; and finally, an x-coordinate value of this position is extracted in real time, where the diameter D=2x;
thirdly, the factors affecting the ultrasonic cutting speed of the outer paraboloid 102 of the honeycomb material are very complex, before regulating and controlling the rotational speed n of the rotary platform 2 by the diameter D of the cutting point of the honeycomb blank 1, it is required to build a mathematical model of ultrasonic cutting force, cutting temperature and machining quality with respect to the characteristics of different honeycomb materials, choose various factors such as rotational speed, cutting speed, cutting depth and feeding speed for orthogonal testing, make evaluations according to the test results to obtain optimal ultrasonic cutting parameters such as rotational speed, cutting speed, cutting depth and feeding speed, and build a database of ultrasonic cutting processes for the outer paraboloid 102 of the honeycomb material (which requires use of the honeycomb material and the sharp knife 4, as well as a lot of manpower, material resources and time, however, building the database of the ultrasonic cutting processes for the outer paraboloid 102 of the honeycomb material can provide a powerful technical support for the method for regulating and controlling the ultrasonic cutting speed of the outer paraboloid 102 of the honeycomb material to meet the requirement for mass production of the honeycomb material). Therefore, prior to ultrasonic cutting of the outer paraboloid 102 of the honeycomb material, according to the characteristics of the honeycomb material to be ultrasonically cut and by use of the database of the ultrasonic cutting processes for the outer paraboloid 102 of the honeycomb material, an optimal ultrasonic cutting speed is chosen for the honeycomb material (i.e., the optimal V1, V2, V3 and V4 are chosen).

Specifically, a motor (not shown) is built in the rotary platform 2, and the rotational speed n of the rotary platform 2 may be controlled by means of the motor.

For example, the preset ultrasonic cutting speed value V0 is 3 m/min.

In the embodiments, the ultrasonic cutting speed V of the honeycomb blank 1 is calculated according to a formula:

$$V = \frac{π \times n \times D}{1000} ;$$

where the rotational speed n of the rotary platform 2 is in units of: r/min, the diameter D of the cutting point of the honeycomb blank 1 is in units of: mm, and the ultrasonic cutting speed V of the honeycomb blank 1 is in units of: m/min.

In the embodiments, a three-dimensional coordinate system is built: a three-dimensional coordinate system is built by taking a center point 0 of an upper surface of the honeycomb blank 1 as an origin point; and the diameter D of the cutting point of the honeycomb blank 1 is twice a distance between the cutting point of the honeycomb blank 1 and a Z axis.

In the embodiments, the S1 includes the following steps:
S1-1, the ultrasonic cutting of the outer end face 101 is divided into two stages AB and BC;
S1-2, regulating and controlling an ultrasonic cutting speed of the outer end face 101 of the honeycomb blank 1 in the stage AB: the rotational speed n of the rotary platform 2 is regulated and controlled according to the diameter D of the cutting point of the honeycomb blank 1 to keep the cutting speed of the honeycomb blank 1 at a constant value V1; and
S1-3, regulating and controlling an ultrasonic cutting speed of the outer end face 101 of the honeycomb blank 1 in the stage BC: regulating and controlling the rotational speed n of the rotary platform 2 is regulated and controlled according to the diameter D of the cutting point of the honeycomb blank 1 to keep the cutting speed of the honeycomb blank 1 at the constant value V1;
where a point B is a midpoint of AC. Thus, since the diameter D of the cutting point of the outer end face 101 changes a lot, the rotational speed n of the rotary platform 2 is subject to a great gradient change when the rotational speed n of the rotary platform 2 is adjusted directly, which is not conductive to the ultrasonic cutting of the honeycomb blank 1. Therefore, dividing the ultrasonic cutting of the outer end face 101 into the two stages AB and BC can further improve the ultrasonic cutting quality of the outer end face 101 of the honeycomb material.

In the embodiments, in S1, requirements for ultrasonic cutting of the outer end face 101 are as follows: a cutting depth L1, a cutting length L2, and a radius L4 of a cylinder left by the honeycomb blank 1 after ultrasonic cutting; a cutting path of the outer end face 101 is: a straight line parallel to an XOY plane; a variation trend of the diameter D of the cutting point of the honeycomb blank 1 is a straight line; coordinates of a point A are (−(L4+L2), −L1), coordinates of a point B are (−(L4+L2/2), −L1), and coordinates of a point C are (−L4, −L1); the diameter D of the cutting point of the honeycomb blank 1 is 2 (L4+L2) when the cutting point of the honeycomb blank 1 is the point A; the diameter D of the cutting point of the honeycomb blank 1 is 2L4+L2 when the cutting point of the honeycomb blank 1 is the point B; and the diameter D of the cutting point of the honeycomb blank 1 is 2L4 when the cutting point of the honeycomb blank 1 is the point C. In S2, a requirement for cutting the outer paraboloid 102 in the roughing stage is as follows: a spacing between a cutting face and the outer paraboloid 102 is L3; a cutting path of the outer paraboloid 102 in the roughing stage is: forming an angle α with the XOY plane, and 0°<α<90°; and a variation trend of the diameter D of the cutting point of the honeycomb blank 1 is a straight line.

In the embodiments, in S3 and S4, a cutting path of the outer paraboloid 102 in the finishing stage is: a parabola taking the XOZ plane or a YOZ plane as a reference plane and passing through points 0 and C; and a variation trend of the diameter D of the cutting point of the honeycomb blank 1 is a parabola.

In the embodiments, in S5, a cutting path of the outer peripheral face 103 is: a straight line parallel to a Z axis and passing through a point A; the diameter D of the cutting point of the honeycomb blank 1 remains unchanged, and D=2 (L4+L2); and the cutting speed value V4 of the honeycomb blank 1 is calculated according to a formula:

$$V 4 = \frac{π \times n 4 \times 2 ( L 4 + L 2 )}{1000} .$$

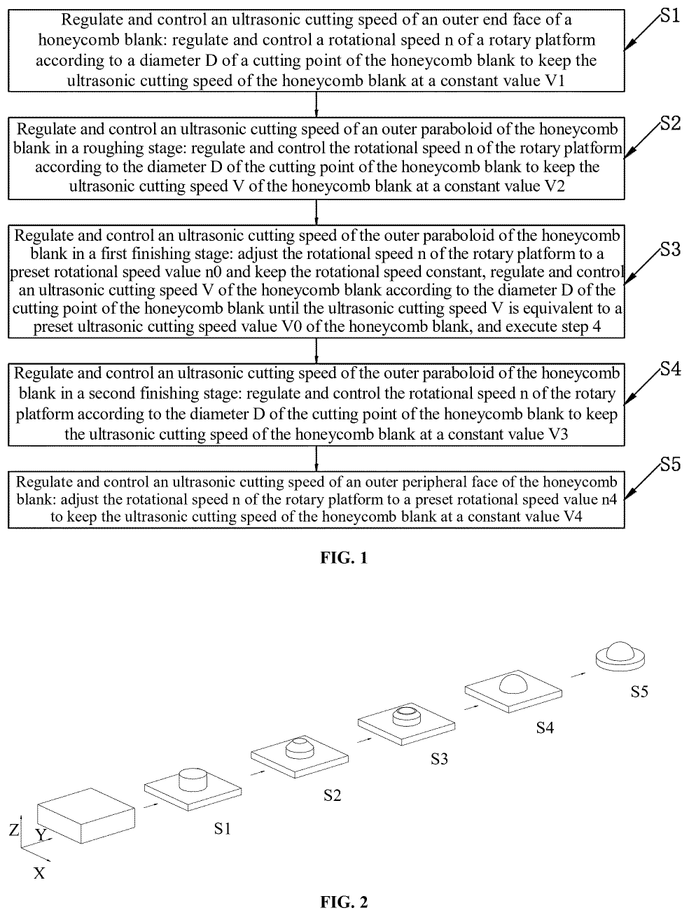

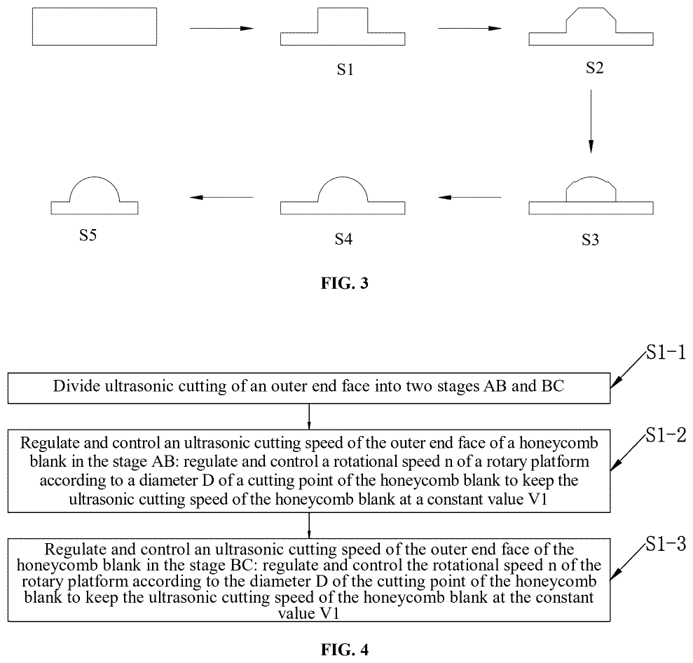

Specifically, in the ultrasonic cutting stage of the outer end face 101, the ultrasonic cutting speed of the honeycomb blank 1 is kept at the constant value V1 (i.e., the rotational speed n of the rotary platform 2 is adjusted according to the diameter D of the cutting point), and the sharp knife 4 is driven by a driving mechanism 3 (at this time, an included angle between the sharp knife 4 and the XOY plane is 3 (the purpose is to avoid friction of a side edge face of the sharp knife 4 against a machined surface of the honeycomb blank 1, which affects the quality of the machined surface)) to perform multiple ultrasonic cutting on the honeycomb blank 1 so as to form the outer end face 101 by means of cutting (i.e., the effect diagram of S1 in FIGS. 2 and 3). When the ultrasonic cutting of the outer paraboloid 102 is in a roughing stage, the ultrasonic cutting speed of the honeycomb blank 1 is kept at the constant value V2 (i.e., the rotational speed n of the rotary platform 2 is adjusted according to the diameter D of the cutting point), and the sharp knife 4 is driven by the driving mechanism 3 (at this time, an included angle between the sharp knife 4 and the XOY plane is a) to perform multiple ultrasonic cutting on the honeycomb blank 1 (i.e., the effect diagram of S2 in FIGS. 2 and 3). During ultrasonic cutting of the outer paraboloid 102 in the first finishing stage, the ultrasonic cutting speed V of the honeycomb blank 1 does not exceed the preset ultrasonic cutting speed value V0 (i.e., the rotational speed n of the rotary platform 2 is constant, and the ultrasonic cutting speed V is adjusted according to the diameter D of the cutting point), and the sharp knife 4 is driven by the driving mechanism 3 (at this time, the sharp knife 4 coincides with a tangent line of a parabola cutting point where the parabola is located) to perform multiple ultrasonic cutting on the honeycomb blank 1 (i.e., the effect diagram of S3 in FIGS. 2 and 3). During ultrasonic cutting of the outer paraboloid 102 in the second finishing stage, the ultrasonic cutting speed of the honeycomb blank 1 is kept at the constant value V3 (i.e., the rotational speed n of the rotary platform 2 is adjusted according to the diameter D of the cutting point), and the sharp knife 4 is driven by the driving mechanism 3 (at this time, the sharp knife 4 coincides with a tangent line of a parabola cutting point where the parabola is located) to perform multiple ultrasonic cutting on the honeycomb blank 1 (i.e., the effect diagram of S4 in FIGS. 2 and 3) so as to form the outer paraboloid 102 by means of cutting (i.e., roughing, first finishing stage, and second finishing stage are performed in sequence). In the ultrasonic cutting stage of the outer peripheral face 103, the ultrasonic cutting speed of the honeycomb blank 1 is kept at the constant value V4 (i.e., neither the diameter D of the cutting point nor the rotational speed n of the rotary platform 2 changes), and the sharp knife 4 is driven by the driving mechanism 3 (at this time, the side edge face of the sharp knife 4 is parallel to an XOZ plane or a YOZ plane) to perform ultrasonic cutting on the honeycomb blank 1 so as to form the outer peripheral face 103 by means of cutting (i.e., the effect diagram of S5 in FIGS. 2 and 3).

Specifically, the driving mechanism 3 includes: a six-DOF robot 5, an amplitude transformer 6 and an ultrasonic transducer 7. The amplitude transformer 6 and the ultrasonic transducer 7 are both connected with an output end of the six-DOF robot 5 by means of an adapter board 8, an input end of the amplitude transformer 6 is connected with the ultrasonic transducer 7, and an output end of the amplitude transformer 6 is connected with the sharp knife 4.

In the following, a detailed explanation is made by taking the outer end face 101 having a cutting depth of 300 mm, a cutting length of 150 mm and a cutting cylinder radius of 300 mm, and the outer paraboloid 102 having a radius of 300 mm as an example.

When the ultrasonic cutting speed V of the outer end face 101, the outer paraboloid 102 in the roughing stage and in the second finishing stage, and the outer peripheral face 103 of the honeycomb blank 1 is set to 188.4 m/min, the rotational speed n of the rotary platform 2 at the point A is 66.67 r/min, the rotational speed n of the rotary platform 2 at the point B is 80 r/min, and the rotational speed n of the rotary platform 2 at the point C is 100 r/min.

In summary, according to the present disclosure, the ultrasonic cutting speed is an important parameter of the numerical control ultrasonic cutting machine tool for the outer paraboloid 102 of the honeycomb material, which directly affects the machining quality of the outer paraboloid 102 of the honeycomb material and the wear of a sharp knife 4. In addition, the ultrasonic cutting speed V is affected by the diameter D of the cutting point and the rotational speed n of the rotary platform 2. Thus, compared with an ultrasonic cutting method in which the rotational speed n of the rotary platform 2 is unchanged and the ultrasonic cutting speed V is changed, the ultrasonic cutting method in which the ultrasonic cutting speed V is kept constant by adjusting the rotational speed n of the rotary platform 2 in all ultrasonic cutting areas other than an area near a point 0 of the outer paraboloid 102 of the honeycomb material can ensure the consistent machining quality of each position of the outer paraboloid 102 of the honeycomb material, which in turn can improve the machining quality of the honeycomb blank 1. Meanwhile, it can be ensured that the sharp knife 4 is always worn at a normal wear speed, rather than being subjected to severe wear or abnormal damage, which in turn can ensure the service life of the sharp knife 4.

The above descriptions are based on ideal embodiments of the present disclosure as enlightenment, and with the above descriptions, relevant staff can make various changes and modifications without deviating from the scope of the technical ideas of the present disclosure. The technical scope of the present disclosure is not limited to what is stated in the specification, and must be determined according to the scope of the claims.

What is claimed is:

1. A method for regulating and controlling an ultrasonic cutting speed of an outer paraboloid of a honeycomb material, comprising the following steps:
step 1, regulating and controlling an ultrasonic cutting speed of an outer end face (101) of a honeycomb blank (1): regulating and controlling a rotational speed n of a rotary platform (2) according to a diameter D of a cutting point of the honeycomb blank (1) to keep the ultrasonic cutting speed of the honeycomb blank (1) at a constant value V1;
step 2, regulating and controlling an ultrasonic cutting speed of an outer paraboloid (102) of the honeycomb blank (1) in a roughing stage: regulating and controlling the rotational speed n of the rotary platform (2) according to the diameter D of the cutting point of the honeycomb blank (1) to keep the ultrasonic cutting speed of the honeycomb blank (1) at a constant value V2;
step 3, regulating and controlling an ultrasonic cutting speed of the outer paraboloid (102) of the honeycomb blank (1) in a first finishing stage: adjusting the rotational speed n of the rotary platform (2) to a preset rotational speed value n0 and keeping the rotational speed constant, regulating and controlling an ultrasonic cutting speed V of the honeycomb blank (1) according to the diameter D of the cutting point of the honeycomb blank (1) until the ultrasonic cutting speed V is equivalent to a preset ultrasonic cutting speed value V0 of the honeycomb blank (1), and executing step 4;
step 4, regulating and controlling an ultrasonic cutting speed of the outer paraboloid (102) of the honeycomb blank (1) in a second finishing stage: regulating and controlling the rotational speed n of the rotary platform (2) according to the diameter D of the cutting point of the honeycomb blank (1) to keep the ultrasonic cutting speed of the honeycomb blank (1) at a constant value V3; and
step 5, regulating and controlling an ultrasonic cutting speed of an outer peripheral face (103) of the honeycomb blank (1): adjusting the rotational speed n of the rotary platform (2) to a preset rotational speed value n4 to keep the ultrasonic cutting speed of the honeycomb blank (1) at a constant value V4;
wherein V1=V2=V3=V4.

2. The method for regulating and controlling an ultrasonic cutting speed of an outer paraboloid of a honeycomb material according to claim 1, wherein the ultrasonic cutting speed V of the honeycomb blank (1) is calculated according to a formula:
$$V = \frac{π \times n \times D}{1000} ;$$
wherein the rotational speed n of the rotary platform (2) is in units of: r/min, the diameter D of the cutting point of the honeycomb blank (1) is in units of: mm, and the ultrasonic cutting speed V of the honeycomb blank (1) is in units of: m/min.

3. The method for regulating and controlling an ultrasonic cutting speed of an outer paraboloid of a honeycomb material according to claim 1, wherein building a three-dimensional coordinate system is that:
a three-dimensional coordinate system is built by taking a center point 0 of an upper surface of the honeycomb blank (1) as an origin point.

4. The method for regulating and controlling an ultrasonic cutting speed of an outer paraboloid of a honeycomb material according to claim 3, wherein the diameter D of the cutting point of the honeycomb blank (1) is:
twice a distance between the cutting point of the honeycomb blank (1) and a Z axis.

5. The method for regulating and controlling an ultrasonic cutting speed of an outer paraboloid of a honeycomb material according to claim 1, wherein the step 1 comprises the following steps:
step 1-1, dividing ultrasonic cutting of the outer end face (101) into two stages AB and BC;
step 1-2, regulating and controlling an ultrasonic cutting speed of the outer end face (101) of the honeycomb blank (1) in the stage AB: regulating and controlling the rotational speed n of the rotary platform (2) according to the diameter D of the cutting point of the honeycomb blank (1) to keep the cutting speed of the honeycomb blank (1) at the constant value V1; and
step 1-3, regulating and controlling an ultrasonic cutting speed of the outer end face (101) of the honeycomb blank (1) in the stage BC: regulating and controlling the rotational speed n of the rotary platform (2) according to the diameter D of the cutting point of the honeycomb blank (1) to keep the cutting speed of the honeycomb blank (1) at the constant value V1;
wherein a point B is a midpoint of AC.

6. The method for regulating and controlling an ultrasonic cutting speed of an outer paraboloid of a honeycomb material according to claim 1, wherein in the step 1, requirements for ultrasonic cutting of the outer end face (101) are as follows:
a cutting depth L1, a cutting length L2, and a radius L4 of a cylinder left by the honeycomb blank (1) after ultrasonic cutting;
a cutting path of the outer end face (101) is:
a straight line parallel to an XOY plane; and
a variation trend of the diameter D of the cutting point of the honeycomb blank (1) is a straight line.

7. The method for regulating and controlling an ultrasonic cutting speed of an outer paraboloid of a honeycomb material according to claim 6, wherein in the step 1, coordinates of a point A are (−(L4+L2), −L1), coordinates of a point B are (−(L4+L2/2), −L1), and coordinates of a point C are (−L4, −L1);
the diameter D of the cutting point of the honeycomb blank (1) is 2 (L4+L2) when the cutting point of the honeycomb blank (1) is the point A;
the diameter D of the cutting point of the honeycomb blank (1) is 2L4+L2 when the cutting point of the honeycomb blank (1) is the point B; and
the diameter D of the cutting point of the honeycomb blank (1) is 2L4 when the cutting point of the honeycomb blank (1) is the point C.

8. The method for regulating and controlling an ultrasonic cutting speed of an outer paraboloid of a honeycomb material according to claim 1, wherein in the step 2, a requirement for cutting the outer paraboloid (102) in the roughing stage is as follows:
a spacing between a cutting face and the outer paraboloid (102) is L3;
a cutting path of the outer paraboloid (102) in the roughing stage is:
forming an included angle α with an XOY plane, and 0°<α<90°; and
a variation trend of the diameter D of the cutting point of the honeycomb blank (1) is a straight line.

9. The method for regulating and controlling an ultrasonic cutting speed of an outer paraboloid of a honeycomb material according to claim 1, wherein in the step 3 and in the step 4, a cutting path of the outer paraboloid (102) in the finishing stage is:
a parabola taking an XOZ plane or a YOZ plane as a reference plane and passing through points 0 and C; and
a variation trend of the diameter D of the cutting point of the honeycomb blank (1) is a parabola.

10. The method for regulating and controlling an ultrasonic cutting speed of an outer paraboloid of a honeycomb material according to claim 1, wherein in the step 5, a cutting path of the outer peripheral face (103) is:
a straight line parallel to a Z axis and passing through a point A;
the diameter D of the cutting point of the honeycomb blank (1) remains unchanged, and D=2 (L4+L2); and
a cutting speed value V4 of the honeycomb blank (1) is calculated according to a formula:
$$V 4 = \frac{π \times n 4 \times 2 ( L 4 + L 2 )}{1000} .$$
